(19) United States
(12) Patent Application Publication
(10) Pub. No.: US 2026/0104887 A1
(43) Pub. Date: Apr. 16, 2026

(54) MINIMAL IMPACT SOFTWARE UPDATE DEPLOYMENT

(71) Applicant: Robert Bosch GmbH, Stuttgart (DE)

(72) Inventors: SEKAR KULANDAIVEL, Pittsburgh, PA (US); JORGE GUAJARDO MERCHAN, Pittsburgh, PA (US); STEFAN GEHRER, Pittsburgh, PA (US)

(21) Appl. No.: 18/916,279

(22) Filed: Oct. 15, 2024

(51) Int. Cl. G06F 8/656

(52) U.S. Cl. CPC G06F 8/656

(57) ABSTRACT

Minimal impact patching of a software application is provided. One or more placeholder code areas are allocated within the code segments of the software application. A plurality of locations within code segments of a software application are identified for placement of placeholders, the placeholders including placeholder instructions configured to selectively call code placed in the placeholder code areas. The software application is built including the placeholder instructions and the placeholder code areas.

### TECHNICAL FIELD

Aspects of the disclosure generally relate to building a software application facilitating minimal impact patching as well as deployment of software updates with minimal impact on original code sections of the software application.

### BACKGROUND

Software diversity is a security and performance enhancement technique that leverages the modularity of computing software by using various implementations, or variations, of software modules. By utilizing different versions of a module that perform the same functionality but have different code structures, software diversity reduces the likelihood that a vulnerability in one module variation will compromise the entire system. This inconsistency in module implementations across different devices makes it more difficult for malware to exploit the same vulnerability widely, thereby increasing the overall security and robustness of the software ecosystem.

Frameworks may be used for performing delta updates, where the update itself contains just the delta (i.e., parts of the code that are different) of the new code versus the old code. This approach saves on over-the-air (OTA) resources, time, and computing constraints.

### SUMMARY

In one or more illustrative examples, a method for facilitating minimal impact patching includes allocating one or more placeholder code areas within code segments of a software application; identifying a plurality of locations within the code segments of the software application for placement of placeholders, the placeholders including placeholder instructions configured to selectively call code placed in the placeholder code areas; and building the software application including the placeholder instructions and the placeholder code areas.

In one or more illustrative examples, identifying the plurality of locations includes one or more of locating the placeholders before calls to cryptographic functions located in the code segments of the software application; locating the placeholders at beginnings of functions located in the code segments of the software application; or locating the placeholders at ends of functions located in the code segments of the software application.

In one or more illustrative examples, the method includes locating the placeholder instructions before and/or after security functions to allow the security functions to be augmented or replaced.

In one or more illustrative examples, the method includes generating basic blocks of instructions and edges that are changes in control flow of the instructions; and locating the placeholder instructions at the entry and/or exit points of the basic blocks.

In one or more illustrative examples, the method includes locating the placeholder instructions to produce a pattern unique to the software application for identifying the software application.

In one or more illustrative examples, the method includes choosing the placeholder instructions to include a power consumption pattern unique to the software application for identifying the software application.

In one or more illustrative examples, the placeholder instructions are predefined to be modified and/or replaced with other one or more instructions to call a section of code in the placeholder code areas that is not initially being called in the software application.

In one or more illustrative examples, the method includes allocating a patch table within the software application, the patch table defining a data structure that includes a set of bits indicative of which of the placeholder instructions should execute a patch; and defining the placeholder instructions to include a check whether a particular patch-ready bit corresponding to the respective placeholder instruction is set, followed a conditional jump based on a result of the check.

In one or more illustrative examples, the method includes defining the placeholder instructions to include an unconditional call to the placeholder code areas, each unconditional call including a return address; and including, in the placeholder code areas, functions that execute patches keyed to the specific placeholders based on the return address.

In one or more illustrative examples, a plurality of placeholders each call the same placeholder code area.

In one or more illustrative examples, the method includes allocating a message authentication code (MAC) table within the software application, the MAC table defining a data structure that includes a unique signature corresponding to each of the placeholders; and defining the placeholder instructions to include a check whether a particular signature corresponding to the respective placeholder instruction is a match to a MAC computed from the placeholder instructions, followed a conditional jump based on a result of the check.

In one or more illustrative examples, the method includes maintaining the MAC table to a hardware security module.

In one or more illustrative examples, a system for facilitating minimal impact patching includes an electronic control unit (ECU) having a memory and a processor, wherein the ECU is configured to receive a software application, the software application comprising one or more placeholder code areas allocated within code segments of the software application; a plurality of locations within code segments of the software application at which placeholders are placed, the placeholders including placeholder instructions configured to selectively call code placed in the placeholder code areas; and wherein the software application is built including the placeholder instructions and the placeholder code areas.

In one or more illustrative examples, to identify the plurality of locations includes one or more of to locate the placeholders before calls to cryptographic functions located in the code segments of the software application; locate the placeholders at beginnings of functions located in the code segments of the software application; or locate the placeholders at ends of functions located in the code segments of the software application.

In one or more illustrative examples, the placeholder instructions are located before and/or after security functions to allow the security functions to be augmented or replaced.

In one or more illustrative examples, a compiler generates basic blocks of instructions and edges that are changes in control flow of the instructions, and the placeholder instructions are located at the entry and/or exit points of the basic blocks.

In one or more illustrative examples, the placeholder instructions are located to produce a pattern unique to the software application for identifying the software application.

In one or more illustrative examples, the placeholder instructions are chosen to include a power consumption pattern unique to the software application for identifying the software application.

In one or more illustrative examples, the placeholder instructions are predefined to be modified and/or replaced with other one or more instructions to call a section of code in the placeholder code areas that is not initially being called in the software application.

In one or more illustrative examples, the software application further comprises a patch table allocated within the software application, the patch table defining a data structure that includes a set of bits indicative of which of the placeholder instructions should execute a patch, wherein the placeholder instructions are defined to include a check whether a particular patch-ready bit corresponding to the respective placeholder instruction is set, followed a conditional jump based on a result of the check.

In one or more illustrative examples, the placeholder instructions are defined to include unconditional calls the placeholder code areas, each unconditional call including a return address and the placeholder code areas include functions that execute patches keyed to the specific placeholders based on the return address.

In one or more illustrative examples, a plurality of placeholders each call the same placeholder code area.

In one or more illustrative examples, the software application further comprises a MAC table allocated within the software application, the MAC table defining a data structure that includes a unique signature corresponding to each of the placeholders, wherein the placeholder instructions include a check whether a particular signature corresponding to the respective placeholder instruction is a match to a MAC computed from the placeholder instructions, followed a conditional jump based on a result of the check.

In one or more illustrative examples, the MAC table is stored to a hardware security module of the ECU.

### BRIEF DESCRIPTION OF THE DRAWINGS

FIG. 1 illustrates an example detail of the components of an electronic control unit (ECU) configured to execute software;

FIG. 2 illustrates an example code segment including a placeholder instruction and a placeholder code area;

FIG. 3 illustrates an example of an update of the placeholder instruction and the placeholder code area to deploy a software update to the software;

FIG. 4 illustrates an example of an update of the placeholder instruction and the placeholder code area to deploy a software update to the software including a remote procedure call;

FIG. 5 illustrates an example of use of a patch table for deploying a software update to the software application;

FIG. 6 illustrates an example of using the CALL instruction before patching a placeholder;

FIG. 7 illustrates an example of using the CALL instruction after patching a placeholder;

FIG. 8 illustrates an example secure approach to validation of patches using a message authentication code (MAC) table;

FIG. 9 illustrates an example software update for one or more of the ECUs;

FIG. 10 illustrates an example process for building a software application facilitating minimal impact patching; and

FIG. 11 illustrates an example process for updating of the placeholder instruction and the placeholder code area to deploy a software update to the software application.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Recent standards and policies require long-term support for managing software security vulnerabilities in the automotive industry. As a result, Original Equipment Manufacturers (OEMs) and their suppliers face challenges in designing and building vehicle computers (or electronic control units (ECUs)) that can be updated 15+ years from the end of production date. These updates that get pushed over a decade into the future require significant effort from the Electronic Control Unit (ECU) designer and product security incident response team (PSIRT). Software updates may require safety testing, and the engineering team may have lost the software development environment and original technical staff.

Aspects of the disclosure relate to methods of inserting placeholder instructions into the original software release of a vehicle or other computer. To update the software, the placeholder instructions or data tested by the placeholder instructions is modified or replaced to cause the placeholder instructions to execute a different section of code on either the same ECU or a different ECU on the vehicle network. This allows for safety or other testing of the fix to be limited to just this allocated section of code, avoid retesting other software components or even the software as a whole.

In contrast to using identifiers to disable an existing version of code, the disclosed approach presents a new technique to perform software updates. Using the disclosed technique, deployment can include not only diverse software but other fixes such as reduced functionality versions and even enhanced security versions of software. Moreover, in contrast to delta updates, the disclosed approach reduces changes to the original code through use of a new memory to implement a software fix. Using the disclosed approach, a software fix can be deployed where only the fix likely needs to be safety tested again as the original code segment remains virtually untouched. Further aspects of the disclosure are discussed in detail herein.

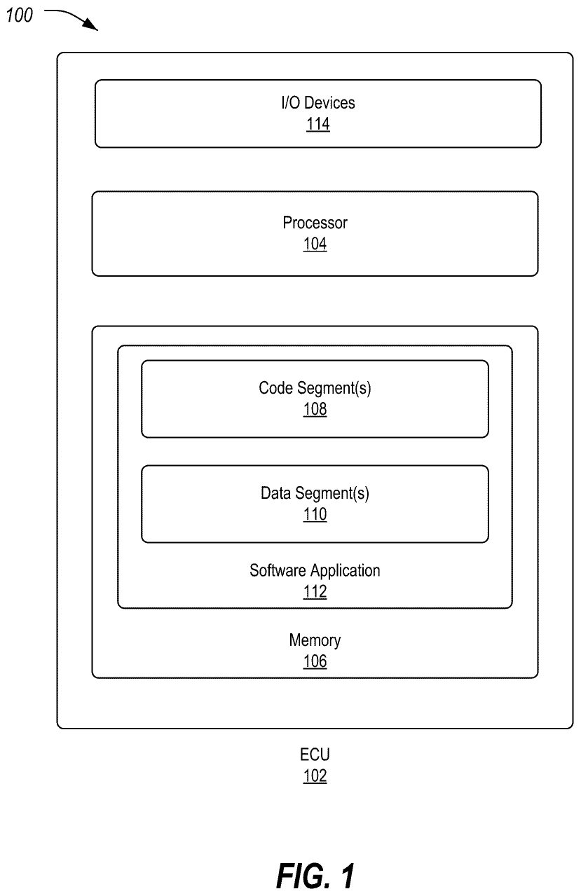

FIG. 1 illustrates an example detail of the components of an ECU 102 configured to execute a software application 112. As shown, the ECU 102 may include a processor 104 and a memory 106. Code segments 108 and data segments 110 of the software application 112 may be stored to the memory 106. The ECU 102 may also include various input/output (I/O) devices 114. It should be noted that this is only an example, and ECUs 102 having more, fewer, or different components or structures may be used.

The processor 104 may be responsible for executing instructions. The processor 104 may fetch instructions from the memory 106, decodes the instructions, executes them, and write back result into the memory 106. The memory 106 may be configured to store the code segments 108 and the data segments 110 that the processor 104 needs to access. The code segments 108 may generally include computer-executable instructions, where the instructions may be executable by the processor 104. The data segments 110 may include information to be operated on by the instructions. Computer-executable instructions may be compiled or interpreted from computer programs created using a variety of programming languages and/or technologies, including, without limitation, and either alone or in combination, Java™, C, C++, C #, Visual Basic, JavaScript, Python, JavaScript, Perl, etc. In general, the processor 104 receives the instructions, e.g., from the memory 106, a computer-readable medium, etc., and executes these instructions, thereby performing one or more processes, including one or more of the processes described herein. Such instructions and data may be stored and transmitted using a variety of computer-readable media.

The I/O devices 114 may include various features that allow the ECU 102 to interact with external components and/or the environment. These may include sensors configured to sense various physical phenomena, transceivers include communications hardware to allow an exchange of information between the ECU 102 and external devices, as well as human machine interface (HMI) devices such as displays, keyboards, and touchscreens to allow a user to interact with the ECU 102.

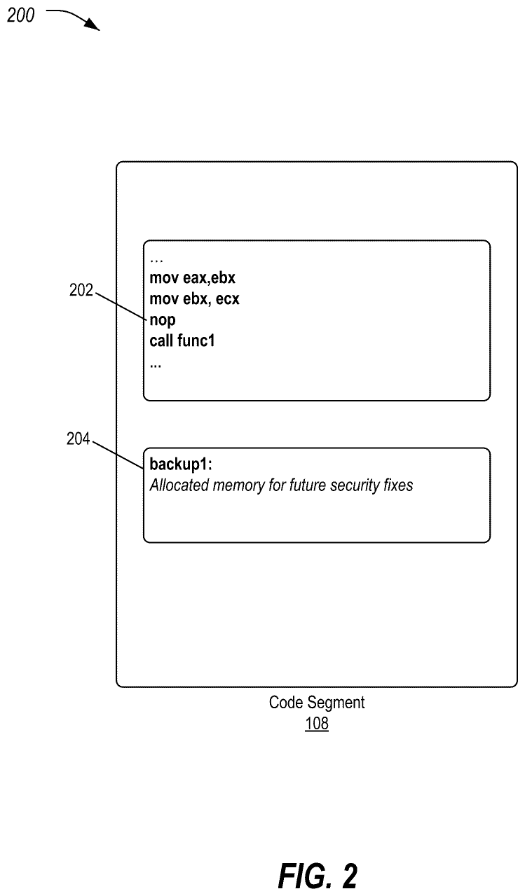

FIG. 2 illustrates an example code segment 108 including a placeholder instruction 202 and a placeholder code area 204. As shown, the example code segment 108 includes a portion of instructions, the placeholder instruction 202, and then further instructions. Also, the code segment 108 includes the placeholder code area 204 which is not presently in the path of execution.

The placeholder instruction 202 refers to one or more instructions in the code path that are predefined in a software build to be modified and/or replaced with other one or more instructions to call a section of code that is not presently being called. The section of code may be resident on either the same ECU 102 or on a different ECU 102 on the network. As shown, the placeholder instruction 202 is a NOP, short for “No Operation,” which is an assembly language instruction that does nothing and simply passes control to the next instruction. Using simple NOP instructions can be sufficient, but the ECU designer may to ensure that the placeholder instruction 202 is not optimized out by the compiler. Moreover, a NOP instruction is easy to identify as a placeholder instruction 202. Thus, other placeholder instructions 202 may be used. The choice of what instruction to use as the placeholder instruction 202 may be up to the ECU designer.

For example, the ECU designer may decide to use a multi-byte NOP or a JMP instruction that points to itself as the placeholder instruction 202. As some further non-limiting examples that may be used alone or in combination, the placeholder instruction(s) 202 may include: moving a register's value to itself (MOV AX, AX), exchanging the value of two registers to itself (XCHG AX, AX), a self-referential operation such as a load effective address to itself (LEA AX, [AX]), a push and pop sequence that leaves a register effectively unchanged, (e.g., PUSH AX, POP AX), an increment decrement sequence that leaves a register effectively unchanged, (e.g., INC AX, DEC AX), applying an operation to a register that doesn't alter the value (e.g., AND AX, AX or OR AX, AX), a compare or test operation that sets flags that are unused by the code flow, or even more complicated appearing logic that has no effect on the function of the software application 112.

This placeholder instruction 202 may be designed to resemble more realistic characteristics of the code segment 108 when performing safety testing. The safety test may analyze timing, register values, etc. so this option may be ideal. The ECU designer could also add a sleep/delay timer (for example, with a maximum delay of a likely or predefined replacement function) at the placeholder location during the verification and validation phase of the software application 112. This approach could ensure that the replacement code would not lead to timing changes or violations.

The placeholder code area 204 refers to a pre-allocated portion of the code segment 108 of a software application 112 that is reserved for future use. The placeholder code area 204 may generally not be included in the code path when the placeholder instruction 202 is unmodified but is included in the code path after the placeholder instruction 202 is modified. It should be noted that in some examples, the placeholder code area 204 includes an allocated without code, while in other examples the placeholder code area 204 may initially include functioning executable code that is simply not turned on.

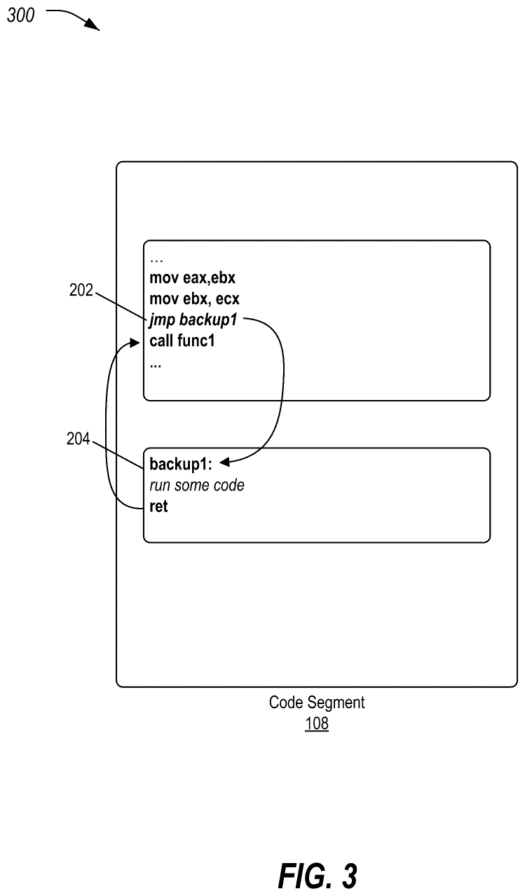

FIG. 3 illustrates an example 300 of an update of the placeholder instruction 202 and the placeholder code area 204 to deploy a software update to the software application 112. As shown, the placeholder instruction 202 is updated from a NOP to a JMP into the placeholder code area 204. Additionally, the placeholder code area 204 is updated to include code which is jumped to and that returns back to after the placeholder instruction 202. Because the memory 106 for the placeholder code area 204 is pre-allocated in the original binary, the scope of the testing that needs to be performed to make the change is more limited in scope as compared to a new build with other portions of the code having been moved or otherwise changed.

An example of the deployment steps to perform this update may be as follows. A need to deploy a vulnerability fix to the ECU 102 is determined. The fix is designed, tested, and implemented (a satisfactory alternative that was prebuilt is identified). A software update is initiated to the ECU 102, where the update includes two modifications. These include replacement of the appropriate placeholder instruction 202 (e.g., blank NOP or blank JMP) with a jump instruction to the allocated placeholder code area 204 in the memory 106 designed to store the vulnerability fix. These also include the code for the vulnerability fix written into the allocated memory 106 (e.g., if a prebuild alternative is not identified). Once these changes are made, the ECU 102 may be restarted and the software update may run.

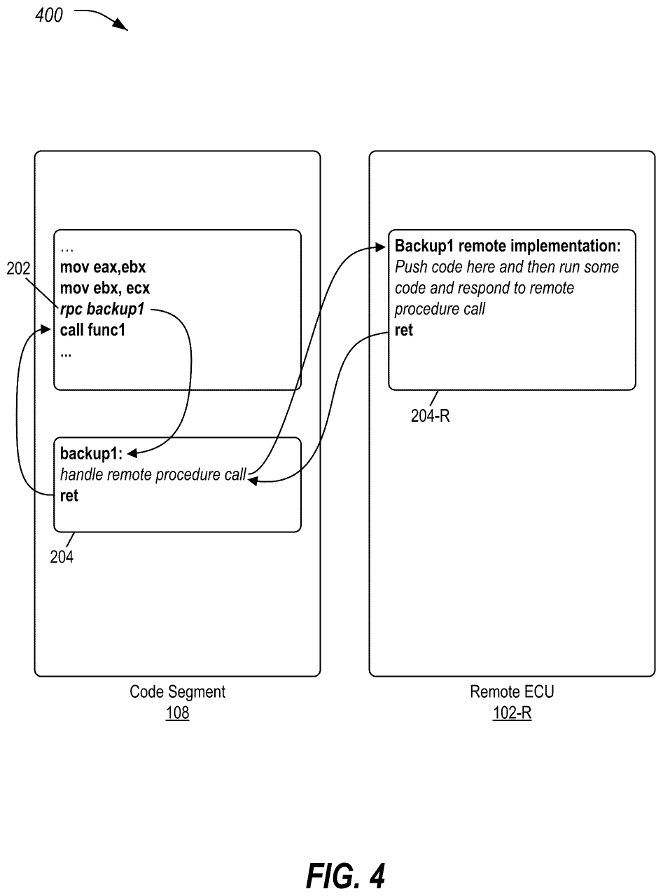

FIG. 4 illustrates an example 400 of an update of the placeholder instruction 202 and the placeholder code area 204 to perform a remote procedure call to implement a software update. As compared to the example 300, in the example 400 the placeholder instruction 202 is again updated to jump to the placeholder code area 204. However, in this case the placeholder code area 204 is updated to handle a remote procedure call to another ECU 102-R (e.g., the “remote” ECU 102). The remote procedure call is configured to execute code in a placeholder code area 204-R of the remote ECU 102-R. The remote procedure call then returns back to the placeholder code area 204 of the ECU 102, which in turn then returns back to the remainder of the code of the code segment 108.

An example of the deployment steps to apply the software update 902 may be as follows. A need to deploy a vulnerability fix to the ECU 102 is determined. The fix is designed, tested, and implemented (a satisfactory alternative that was prebuilt is identified). A software update 902 is initiated to the ECU 102, where the software update 902 includes three modifications. These include replacement of the appropriate placeholder instruction 202 (e.g., blank NOP or blank JMP) with a jump instruction to the allocated placeholder code area 204 memory 106, which is updated to include an implementation to perform the remote procedure call to the other ECU 102-R. Additionally, code implementing the vulnerability fix is created and updated into the memory 106 of the other ECU 102-R. Once these changes are made, the ECU 102 and the ECU 102-R may be restarted and the software update 902 may run.

In some examples, there may be a need to patch the software application 112 with placeholders in code while also complying with various security requirements and/or code certifications. Some requirements may forbid code that has unconditional jumps, for example for ASIL-rated systems. Instead of unconditional jumps, two example alternate implementations are proposed for the placeholder technique while still limiting the length of the placeholder.

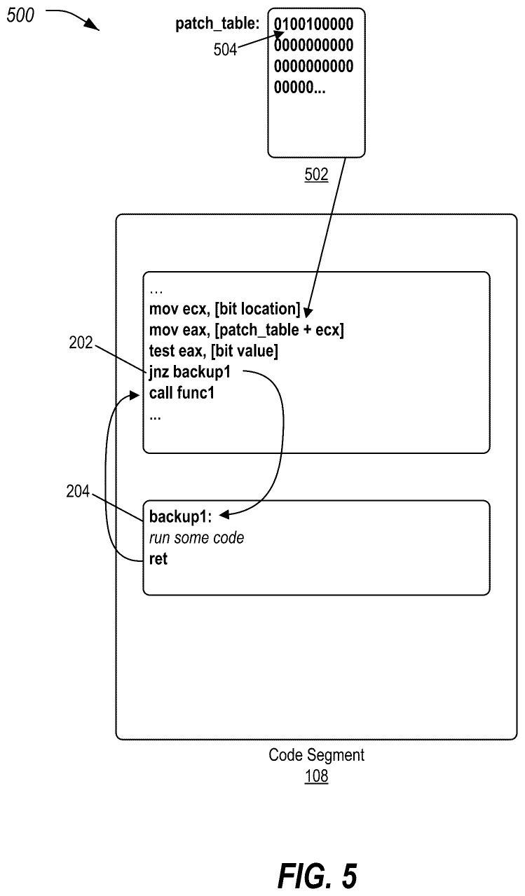

A first option uses a placeholder that contains two portions of instructions: instructions to identify a patch-ready bit (e.g., CMP compare) followed by a conditional jump instruction (e.g., jump if not zero (JNZ)) to the patch itself. The code flow would only divert to the patch if a patch-ready bit is set in data during a patch of the software application 112. This is discussed in detail in FIG. 5.

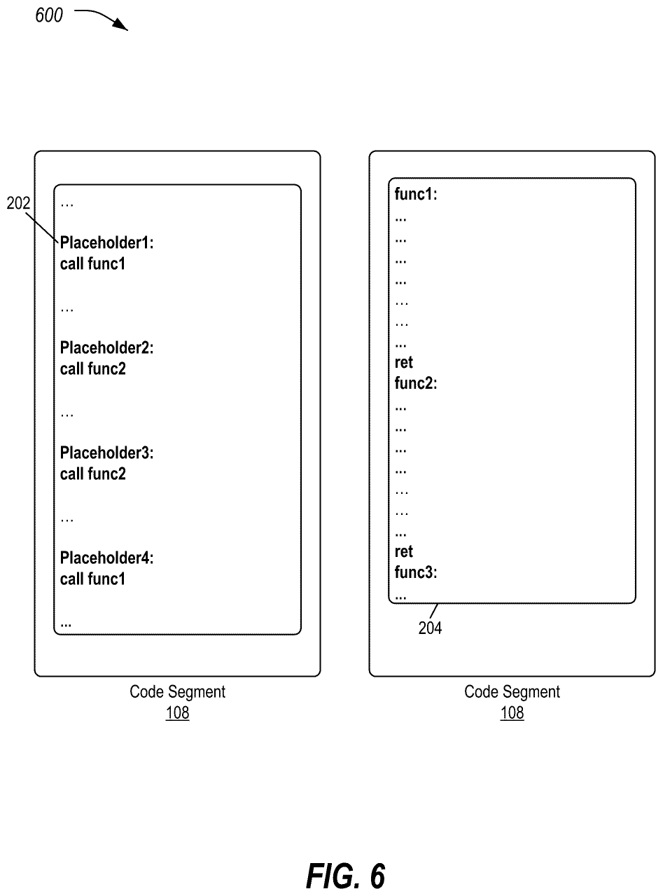

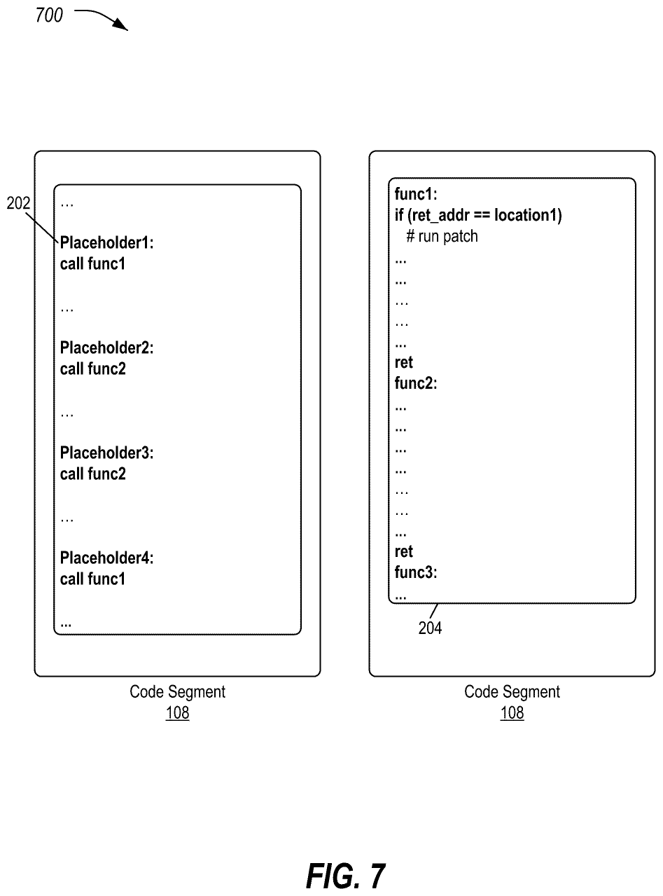

Another option uses an (effectively) two-instruction placeholder that is a function CALL to the patch. A CALL may be referred to as two-instruction since the return address is automatically stored followed by a jump. Since this function would always be called, the function should simply contain a RET return unless the patch modifies the contents of the function. This is discussed in detail in FIGS. 6-7.

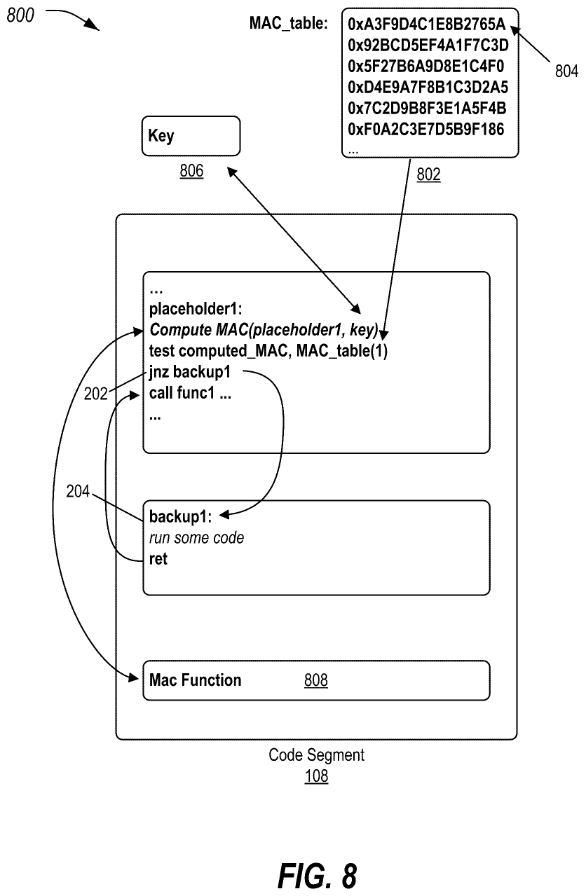

To prevent abuse of placeholders to exit the original code flow for the purpose of an attack, additional techniques may be used to ensure the security of a patched placeholder. One option (to provide authenticity of the patch) is to sign the patch and include a signature with the patch that is verified either before a patch is run or near/at boot time of the ECU. Another option (to provide integrity of the patch) is to include a hash of the patch and have the software application 112 check the hash before running the patch itself. These options are not mutually exclusive. This is discussed in detail in FIG. 8

In some examples, for the purpose of safety-related applications (and possibly security), it is important that the placeholders generated (which define the area of code that could be updated in the future), do not include calls to other functions (in other words there should not be a function call inside another function call), as it may become difficult to guarantee timing and other properties in such a case.

FIG. 5 illustrates an example of use of a patch table 502 for deploying a software update to the software application 112. The patch table 502 is a data structure that includes a set of bits indicate which of the placeholder instructions 202 should execute a patch. These bits may be referred to as patch-ready bits 504 herein. This patch table 502 may be stored in any non-volatile read-only data/memory and may be updated as part of the software patch. To ensure security, it may be desirable in some examples to store the match table 502 to a memory region that can only be written to by high privilege software, such as a secure memory enclave. Each placeholder instruction 202 is tied to a patch-ready bit in the read-only data segment. For 1,000 placeholder instructions 202, 1,000 patch-ready bits will be needed. In such an example, for every placeholder instruction 202 in the ECU code, there may be a corresponding patch-ready bit 504.

As one implementation, a single array of patch-ready bits 504 may be defined, where each placeholder instruction 202 is set to check a specific position in that array. In some examples, the bits may be in the same order as the placeholder instructions 202, but the ordering could be arbitrary.

In this approach, the placeholder instructions 202 check whether a particular patch-ready bit 504 is set, followed a conditional jump, such as JNE or JNZ, based on the preceding check results. The patch-ready bit 504 may be set as part of a software patch to indicate that a patch exists for use. The patch-ready bit 504 may be checked by first loading the appropriate byte from memory into a register and then testing if the specific bit 504 (for patch X) is set. Depending on which assembly instruction is used to test the bit, the conditional jump may check a flag to determine if a jump will take place. It should be noted that the code instructions shown in FIG. 5 are simplified and omit bit shifting and other additional operations that may be required to test for a specific bit 504 within a fetched byte of the patch table 502.

To perform a patch X with this type of placeholder instruction 202, there may be two or three locations/steps to update the code for patch X: (a) load the patch into the placeholder code area 204, (b) set the patch table 502 at position X to indicate a patch is ready for a given placeholder instruction 202 at code location X, and (c) replace the NOP instruction (if not already a jump) to a conditional jump that points to the location of patch X in the allocated memory.

FIGS. 6-7 collectively illustrate an example of using a CALL instruction in combination with fewer placeholder code areas 204 than placeholder instructions 202. FIG. 6 illustrates an example 600 of using the CALL instruction before patching a placeholder. FIG. 7 illustrates an example 700 of using the CALL instruction after patching a placeholder.

Generally, the CALL instruction pushes a return address onto the stack (typically of the instruction after the CALL instruction) and then jumps to the given address to be called. Although this method is only one assembly instruction, it effectively performs two steps and requires the requisite CPU cycles to do so.

If a system has not been updated with a patch, then this CALL instruction may call an empty placeholder code area 204 that simply contains a return (RET) instruction. In one example, a dedicated empty function in a placeholder code area 204 may be included in an original release of the software application 112, and all unused placeholder instructions 202 may call this function by default. In another example, the placeholder instructions 202 may be assigned to call different placeholder code areas 204, where the initial placeholder code areas 204 are simple ret instructions.

To perform a patch X with this type of placeholder, there may be two steps to update the code: (a) load patch X itself into the allocated memory of the placeholder code area 204; and, if required, (b) modify the CALL instruction pointing to the empty placeholder code area 204 function to instead CALL patch X.

As shown in FIGS. 6-7, multiple placeholder instructions 202 can point to the same empty function. When a patch is performed, the empty placeholder code area 204 may contain the patch contents and only run if the appropriate placeholder instructions 202 call that function. This prevents other placeholder instructions 202 that point to the same empty function from being patched at the benefit of offering a quicker runtime of the patch.

It may be desirable to avoid replacing the placeholder instructions 202 when performing the patch, instead may only require modifying the unused memory of the placeholder code area 204 for the fix itself. Doing so may reduce the amount of safety testing. In such an example, multiple placeholder instructions 202 may share the same placeholder code area 204 to check for a patch. There may be different implementations of this approach (that are not mutually exclusive).

For instance, each placeholder may be assigned to its own default function. These may initially be empty and simply contain a ret instruction. Prior to a patch, the placeholder instructions 202 will simply call the function in this placeholder code area 204, which quickly executes the ret instruction to return to the original code flow. During a patch, the function in the placeholder code area 204 may be replaced with the contents of the patch.

The empty (default) function that the placeholders call may be replaced by a function that checks the return address of the calling function and then performs the patch for that specific placeholder. By starting the patch with a compare of the return address (the location of the placeholder instructions 202), a failed compare will simply return to the placeholder (e.g., to the return address pushed by the CALL), while a successful compare will continue to run the patch and then return to the return address.

If there are multiple patches made to a system, to the extent that performing a check of the return address (and thus the placeholder location) would utilize over-budget CPU cycles, several empty functions may be utilized in different placeholder code areas 204. In such an approach, multiple placeholders may define placeholder instructions 202 that point to the same empty function as detailed in FIGS. 6-7. For instance, as illustrated placeholders 1 and 4 call func1 while placeholders 2 and 3 call func2. In some examples, a predefined count of placeholders may be assigned to each of the placeholder code areas 204, e.g., each placeholder code area 204 is called by N placeholder instructions 202.

It should be noted that the ECU designer may identify subsets of placeholder code areas 204 that will likely not require multiple patches. This involves a tradeoff in additional program memory usage at release to include multiple empty functions, with the advantage of better runtime performance since there will be fewer or only a single compare function (to identify the associated placeholder) before a patch is run. If a second placeholder is then linked to this same function (previously an empty function but now containing one patch), the function can be updated to perform two different checks (one for each placeholder) which may result in a longer runtime of the patch.

If the location of the patch is pre-defined (as seen in the CALL instructions that point to empty functions), it is important to ensure there is adequate space allocated in the placeholder code area 204 for the contents of a patch in case of multiple patches. If there are several empty functions in series in memory, the addition of a patch to one of these empty functions will result in modifying the address of the following functions in memory (and any other functions). To avoid this possibility, the blocks of memory for a given placeholder code area 204 may be pre-defined. The ECU designer may design the length of the placeholder code areas 204 to provide enough allocated memory to fit the contents of a future patch. This approach avoids modifying the memory location of other allocated memory blocks (in addition to not modifying the placeholder instructions 202 themselves). A tradeoff for this approach is that the number of patches may be limited due to remaining blocks of unused memory if a patch does not fit the entirety of an allocation memory block.

FIG. 8 illustrates an example secure approach to validation of patches using a message authentication code (MAC) table 802. Similar to how the patch table 502 includes a unique bit 504 corresponding to each of the placeholders, the MAC table 302 may include a unique signature 804 corresponding to each of the placeholders.

To prevent exploitation of the contents of a patch, a signature 804 of the patch contents may be included with the patch. Analogous to how a secure boot approach verifies the signature of code at boot time, the contents of the MAC table 302 may be used to verify the signature 804 of the patch shortly after boot time or just before the patch is run.

In some examples, a pre-installed public key 806 may be used to verify the signature 804, and/or a certificate may be validated to increase the level of trust. The MAC function 808 code to perform this signature check (and/or certificate validation if not self-signed) may be included in the original release of the software application 112 so that it is in scope of the original safety testing.

If verifying the integrity of a patch is sufficient for the ECU designer, then a hash of the patch may be computed and compared against the expected hash of the patch, where the expected hash is included in the patch contents. The hash function may be included with the released software application 112, so the hash function would not need to be supplied later. Authenticity of the hash may be verified by comparing the hash computed of the patch with a reference hash value stored (at least partly) in secure memory or fuses, avoiding additional cryptographic operations.

In this example, during secure boot a signature 804 on the patch or full the software application 112 may be verified. During execution of the software application 112 that is expected to be real-time, a public-key operation may not be possible or desired to meet timing requirements. Instead, to provide a level of cryptographic protection, symmetric key operations may be used. It should be noted that a hash value itself may be insufficient to provide adequate protection since a hash only shows that a particular piece of software has not been modified, as opposed to verifying a source of the piece of software.

The MAC table 302 may be stored to a memory region that can only be written to by high privilege software (such as a secure memory enclave used for storing cryptographic keys 806 or where the patch table 502 is stored). The MAC table 302 may store, for each patch, a signature 804 result of computing a MAC with a secret key 806. The secret key 806 may be stored in the secure memory as well or may be provided the software developer outside the ECU (e.g., on a cloud server, from other secure infrastructure, etc.). Various algorithms may be used for computation of the MAC, such as MAC include HMAC (Hash-based MAC), CMAC (Cipher-based MAC), and GMAC (Galois/Counter Mode MAC), as some non-limiting examples.

For each patch, there may be a unique memory address and memory reserved in the MAC table 302 to store the signature 804 result of a MAC for the software patch that is expected to be executed. This memory area may be referred to as a TABLE_OF_APPROVED_PLACEHOLDER_MACS. This approach is similar to the patch array 502 discussed herein.

Each entry in MAC table 302 may contain a MAC computed of the placeholder instructions 202. For instance, the MAC signature 804 may be computed of placeholder instructions 202 including: the instructions to compute the MAC, the instructions to test the MAC, the instructions to jump to the placeholder code area 204, and the return address from the CALL. This ensures that the signature 804 is computed of the relevant instructions for calling the patch.

During a secure boot, the contents of the MAC table 302 may be verified with the public key 806. If a hardware security module (HSM) is available and timing requirements can be met, then the MAC of the placeholder may be computed on-the-fly every time and stored in a register, which can be used for comparison with the expected value in MAC table 302. Regardless of details of the implementation, the patch may only be activated upon condition that the MAC is a match.

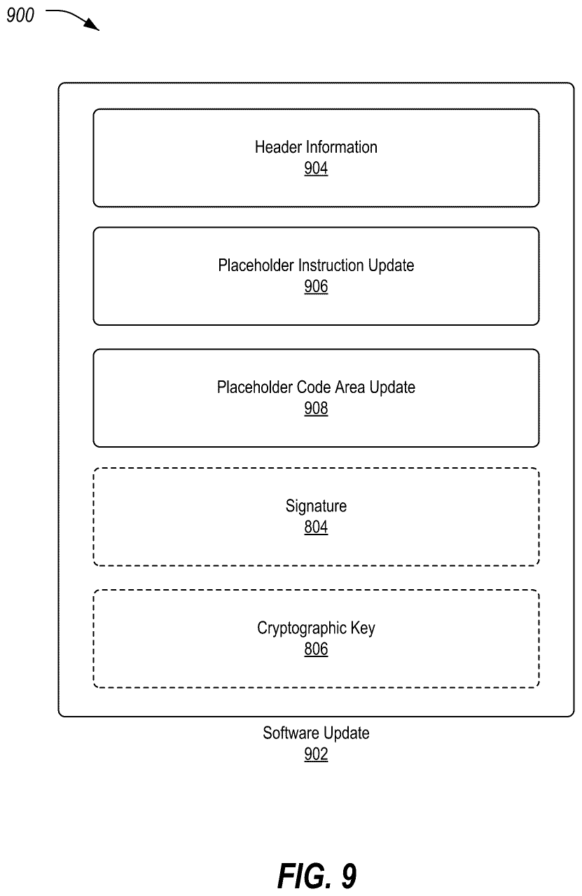

FIG. 9 illustrates an example software update 902 for one or more of the ECUs 102. As shown, the software update 902 may include header information 904, a placeholder instruction update 906, and a placeholder code area update 908. The software update 902 may optionally also include the signature 804 and/or the key 806 discussed with respect to FIG. 8. It should be noted that this is only an example, and software updates 902 having more, fewer, or different fields or structures may be used.

The header information 904 may include information indicative of the ECU 102 to be updated. This may indicate, as an example, a name or unique identifier of the ECU 102. This may also indicate, for instance, a version number of the software application 112 of the ECU 102 to be updated. The header information 904 may be used to ensure that the software update 902 corresponds to the current ECU 102 of the current version to receive the changes.

The placeholder instruction update 906 may include an indication of which placeholder instruction 202 to update. In a simple example, the placeholder instruction update 906 may reference the placeholder instruction 202 by location offset into the code segment 108 to be updated. In another example, each of the placeholder instruction 202 locations may be numbered in a lookup table, and the placeholder instruction update 906 may indicate the number of the placeholder instruction 202 where the address is then retrieved from the lookup.

The placeholder instruction update 906 may also indicate the new instructions to be applied to the placeholder instruction 202. This may be as simple as including the instructions to replace the placeholder instruction 202 with. Or, in another example, the placeholder instruction update 906 may indicate which placeholder code area update 908 to jump to, and the ECU 102 may construct the appropriate jump instruction to put in place of the existing placeholder instruction 202.

In yet another example, the placeholder instruction update 906 may include an indication of an update to be made to the patch array 902. For instance, the placeholder instruction update 906 may indicate which bit 504 of the patch array 902 to update to activate execution of the patch for that corresponding placeholder. In some such examples, the placeholder instructions 202 may not require updating as the test and conditional jump instructions may serve to handle the updated bit 504 in the patch array 902.

The placeholder code area update 908 may include the code of the fix to be applied to the placeholder code area 204. In an example, this may include the instructions to be applied to the placeholder code area 204. In another example, if the potential fix was preloaded into the placeholder code area 204, then the placeholder code area update 908 may indicate that no specific change to the placeholder code area 204 is required.

In some examples, the ECU 102 may utilize a MAC table 802, and the software update 902 may include a signature 804 of the update to be applied. This signature 804 may be applied to the element of the MAC table 802 corresponding to the placeholder being modified. This may cause the placeholder instructions 202 to test and jump to the new placeholder instruction update 906.

In some examples, the software update 902 may include a cryptographic key 806 which may be used to confirm the unique signature 804 (MAC) in the MAC table 802. In other examples, the key 806 may be preinstalled to the ECU 102.

The ECU designer and/or a build process of the software application 112 may identify where to insert the placeholder instructions 202. As inserting placeholder instructions 202 can increase the size of the release code, the designer must take care to limit the number of placeholder instructions 202. Some ideal positions might include before and after security functions, before and after critical functions, before and after open-source functions, before and after third-party functions, etc. With respect to the added code size, a placeholder instruction 202 inserted every 10 lines has a 10% overhead to the code, every 20 lines has a 5% overhead to the code, and so on.

Another approach to identify potential locations for inserting the placeholder instructions 202 is to look at certain properties of the code and insert more placeholder instructions 202 where security rigor is lower. Some properties to distinguish sections of code include application versus firmware code (where firmware typically has more rigor and testing), low-level and less frequently updated code typically has more rigor (such as drivers and other basic functionality code), etc. The number and type of disclosed vulnerabilities (such as common vulnerabilities and exposures (CVEs)) could also indicate which sections of code should have more placeholder instructions 202. Code that has static analysis and other security rigor could likely have a reduced number of placeholder instructions 202. A potential function to consider for the number of placeholder instructions 202 may be a function of the code's update history, the code's creator, and the past CVEs for that code.

Several alternatives may be used for designing the software update 902 that may be deployed to an ECU 102 with the placeholder instructions 202 in its software application 112. These alternatives for the software update 902 may include reduced alternative fixes, stricter alternative fixes, diverse alternative fixes, and/or enhanced alternative fixes. The disclosed approach of using placeholder instructions 202 makes these various types of fixes advantageous as security fixes can be deployed inline with existing code with strategically placed placeholder instructions 202, which are explained herein. Using this approach, the ECU designer can reduce the risk of the overall software application 112 by predicting where likely vulnerabilities could occur and then selecting the appropriate alternative below to mitigate a potential vulnerability.

In a reduced alternative, the software update 902 could simply reduce the functionality of a given block. Some vulnerabilities require a specific feature to be implemented (and then exploited). By eliminating this feature or returning with an error when the specific function is called, a software update 902 could mitigate such a vulnerability. Many automotive software application 112 vendors offer multiple configuration options when generating code for a given project. One approach to implementing this reduced functionality is using a placeholder instruction 202 inserted just before the return of the called function (involved in the vulnerability) to overwrite the return value with an error return value or a “not-supported” return value, which are return values already offered in the configuration. In this case, a feature is effectively removed, and further exploitation of that feature is blocked.

In a stricter alternative, the software update 902 to mitigate a vulnerability may include enhancing an existing security check, such as a counter that tracks the number of attempts or an input sanitizer that strips out potential code injection attacks. One possible stricter alternative to insert at the placeholder instruction 202 location is a different expiration time. In case an expiration time is too long in practice due to a new vulnerability (e.g., diagnostic authentication attack functions in just three attempts instead of ten), the system designer could use this method to implement a smaller expiration time. Another possible stricter alternative to insert includes the use of a different maximum count of login attempts. As with the expiration times, the system designer could prepare another version that reduces the maximum count of login attempts. Another possible stricter alternative includes the use of different error handling. In case an error handling mechanism can be exploited by an attacker (e.g., exploiting a null pointer reference error handling mechanism), the system designer can prepare another version of the error handling response code. Yet another possible stricter alternative includes the use of different input sanitization methods. In case an input sanitization method is not strict enough (e.g., an attack can exploit an edge case to launch a remote code execution attack), the system designer can prepare another input sanitization function.

This approach is advantageous for this type of software update 902 when a placeholder instruction 202 is inserted after existing security checks and within error-handling code blocks. For example, a stricter alternative deployed after an existing security check can perform further sanitization of a particular input (e.g., scrapping semicolons from an input, removing keywords, or even intentionally throwing an error if malicious input is detected). Likewise, within an error-handling block, an example software update 902 could perform additional checks to system state to determine if an error was malicious or not.

In a diverse alternative, the software update 902 to mitigate a vulnerability may include designing different versions of the software application 112 that are functionally equivalent but constructed differently. This may be done to avoid a common weakness, as a solution for mitigating vulnerabilities that exploit a weakness in a block of the construction of the software application 112. Commonly known as software diversity, this approach may be implemented if the different versions are built by independent developers who do not share a programming process. However, a single ECU designer could design multiple versions of the software application 112 using guidance on which functions within that software application 112 are likely to have a currently undiscovered vulnerability. The intent here is to design one or more alternative versions that could be deployed into an existing placeholder instruction 202 and/or selected by updating a placeholder instruction 202 to point to an alternative that was shipped in the existing code but not used.

A non-exhaustive list of approaches for constructing different versions of the software application 112 may include one or more of the following. For instance, different source of randomness may be used, such that case one source is compromised (e.g., controllable by an attacker), the ECU designer could switch to a different source that is not vulnerable. In another example, different cryptographic algorithms could be used, such that in case one type of algorithm is compromised (e.g., algorithm is broken, or the library implemented around the algorithm is broken), the ECU designer could switch to a different algorithm that is not broken. The difference between two algorithms can range from the whole algorithm to a different key size and even changing the initialization vector.

In yet another example, different factors for multi-factor authentication (MFA) may be used, such that in case one factor in an MFA implementation is compromised (e.g., text message codes controllable by attacker), the ECU designer could activate a different factor and require the user to use that factor instead. In still another example, different storage mechanism for credentials may be used, such that in case a storage mechanism for credentials is compromised (e.g., cryptographic hash function is broken), the ECU designer could prepare another mechanism type to activate. In another possibility, different ports may be used such that in case an attack is enabled because a specific port is left open (e.g., cellular port for diagnostic is left open), the ECU designer can prepare another version that uses a different port that does not have the same attack path.

In these examples, the deployed software update 902 would likely replace a block of code to implement a diverse version of that same block. Where the diverse alternative described here could be designed once a vulnerability is identified, the disclosed approach may also be advantageous for designing diverse versions ahead of time (even prior to the ECU's production). By identifying where a placeholder will exist in the ECU's software application 112, an ECU designer can then design and store alternative versions to replace blocks of the software application 112 ahead of time. For example, a future product security incident response team (PSIRT) may access a database of already built and tested software updates 902 stored in a database. If a future identified vulnerability could be mitigated by a software update 902 in this database of diverse alternatives, the PSIRT could push a solution faster without any need for testing.

In addition to the diverse constructs noted above, an ECU designer could use additional techniques to prepare diverse versions ahead of time. For example, different design/coding teams may be used. The ECU designer could contract (at least partly) independent teams to implement the same specifications with the hope that they are unlikely to make the same “mistakes.” Some ways to enforce this include requiring the use of different open-source libraries, different software architectures, etc.

In another example, different coding standards and/or programming languages may be used. The ECU designer could require different teams to build a software update 902 in different languages with the intent to avoid vulnerabilities that are only present in certain languages. For example, an input sanitization function may produce a different output based on the programming language. The different implementations could be obtained by programming in different languages (one can be of a software application 112 function using a high-level language (C/C++, Java, Rust, etc.) or low-level such as assembly). If a particular final language needs to be supported, then a cross-compiler or trans-compiler can be used to translate the first different language to the final desired language.

In still another example, different compilers may be used. The ECU designer could use different compilers to avoid compiler-induced vulnerabilities. For example, a compiler's optimization of a function could remove a boundary condition check where another compiler's optimization would not.

In one or more other examples, a compiler may generate a control-flow graph (CFG), includes basic blocks and edges that are changes in control flow via jump instructions or similar. For some or all of the basic blocks in the CFG, placeholder instructions may be added (such as NOPs (no JUMP instructions, though)) or other instructions that do not modify registers, etc. The placeholder instructions may be added to all of the basic blocks in the CFG or only to some, which have been chosen because they are particularly relevant to some critical functionality. Critical functionality could mean that the basic block implements security functionality (encryptions, signing, hashing, authentication, etc.) or safety critical functionality, as typical examples. From the CFG augmented with the modified basic blocks, the final code is regenerated. This process may be combined with any of the other approaches discussed herein (such as using multiple developer teams or different code languages, etc.). For example, the compiler may generate basic blocks of instructions and edges that are changes in control flow of the instructions, and locate the placeholder instructions at the entry and/or exit points of the basic blocks.

In some examples, a second version of the software application 112 is sufficient. However, for sake of completeness, the number of diverse alternatives could be extended to three, four, and as many as N versions of the software application 112. The implementation of more than two versions may be up to the ECU designer as a trade-off must be made between the benefit of multiple versions and the cost to implement those versions. Some examples of a necessary trade-off are for software functions that are mission-critical functions or safety-critical functions.

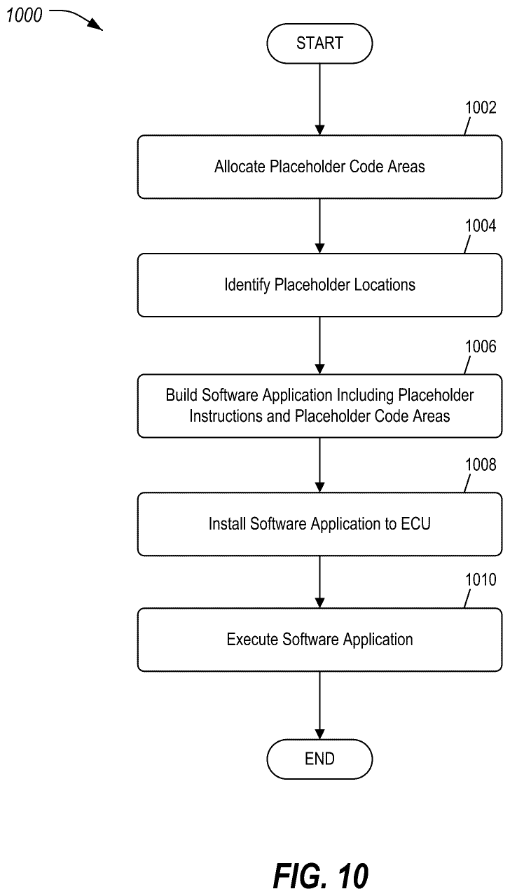

FIG. 10 illustrates an example process 1000 for building a software application 112 that facilitates minimal impact patching. In an example, the process 1000 may performed by one or more computing devices, to cause the software application 112 be applied to one or more of the ECUs 102 discussed in detail herein.

At operation 1002, one or more placeholder code areas are allocated within code segments of a software application 112 to be built. In an example, each placeholder is allocated to a different placeholder code area 204. In other examples, a plurality of placeholders may be assigned to each call the same placeholder code area 204.

At operation 1004, a plurality of locations are identified within code segments of the software application 112 for placement of placeholders. The placeholders including placeholder instructions 202 configured to selectively call code placed in the placeholder code areas 204. In an example, identifying the plurality of locations may include one or more of placing the placeholders before calls to cryptographic functions located in the code segments of the software application; placing the placeholders at beginnings of functions located in the code segments of the software application; or placing the placeholders at ends of functions located in the code segments of the software application. In an example, identifying the plurality of locations may include placing the placeholder instructions before and/or after security functions to allow the security functions to be augmented or replaced. In an example, identifying the plurality of locations may include placing the placeholder instructions to produce a pattern unique to the software application for identifying the software application.

In an example, the placeholder instructions are predefined to be modified and/or replaced with other one or more instructions to call a section of code in the placeholder code areas that is not initially being called in the software application. In another example, a patch table is allocated within the software application defining a data structure that includes a set of bits indicative of which of the placeholder instructions should execute a patch, and the placeholder instructions are defined to include a check whether a particular patch-ready bit 504 corresponding to the respective placeholder instruction is set, followed a conditional jump based on a result of the check. In yet another example, the placeholder instructions are defined to unconditionally call the placeholder code areas, each call including a return address, and in the placeholder code areas, functions that execute patches keyed to the specific placeholders are placed based on the return address.

At operation 1006, the software application 112 is built including the placeholder instructions 202 and the placeholder code areas 204. In an example, the operations 1002, 1004, and 1006 are incorporated into a build process for the software application 112.

At operation 1008, the software application 112 is installed to one or more ECUs 102. For instance, the software application 112 may be installed to the memory 106 of the ECU 102, e.g., when the ECU 102 is built, during assembly of the ECU 102 into a vehicle, based on an over-the-air software update, etc.

At operation 1010, the software application 112 is executed by the one or more ECUs 102. In an example, the software application 112 may be executed by the one of more ECUs to operate various aspects of a vehicle. It should be noted, however, that is only one example, and the techniques discussed in detail herein are applicable to other computing devices and/or computing environments, such as servers, desktop computers, mobile phones, wearables, embedded devices, etc. After operation 1010, the process 1000 ends.

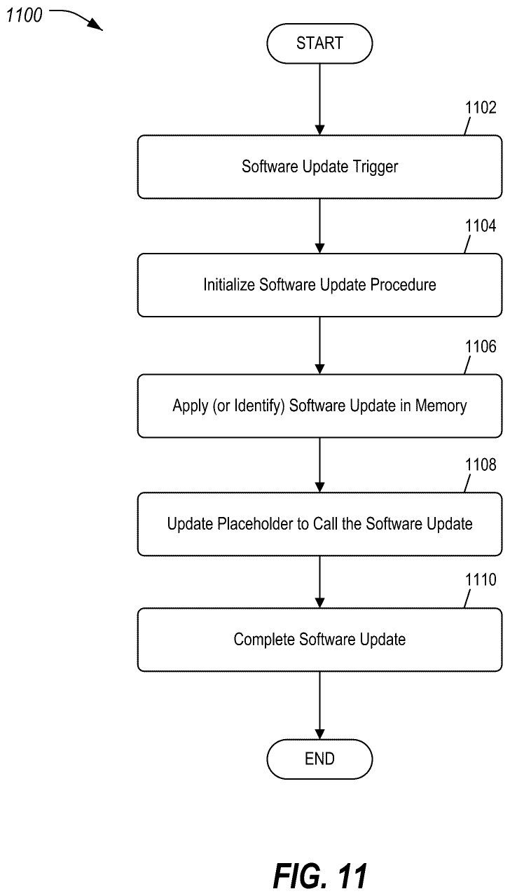

FIG. 11 illustrates an example process 1100 for updating of the placeholder instruction 202 and the placeholder code area 204 to deploy a software update 902 to the software application 112. In an example, the process 1100 may be applied to one or more of the ECUs 102 discussed in detail herein.

At operation 1102, application of a software update 902 is triggered. In an example, the trigger may be a manual interaction. However, in other examples, the trigger may be an automated trigger. In one example of an automated trigger, an intrusion detection and prevention system (IDPS) may be monitoring network and system activities of the ECU 102 for malicious activities or policy violations and take action to in view of an identified threats. In another example, an internal mechanism of the vehicle or other device including the ECUs 102 triggers activation of a software update 902 (e.g., an enhanced alternative) for a particular section of code, e.g., by providing a software update 902 to the ECUs 102 to be updated.

It should be noted that a trigger approach may include combinations of techniques and it not necessary to choose just one approach. In some examples, a deployment strategy may elect multiple techniques. For example, a deployment strategy could split decisions for a novel vulnerability detection into major and minor decisions. For major decisions that require approval from leadership and risk analysis by the PSIRT, those software updates 902 could be deployed on command instead of automatically. For minor decisions or even safety-relevant decisions that need to be implemented in real-time scales, these deployments may occur without obtaining approval from a human. Such an automatic deployment assumes that there is enough information gathered on the vehicle or other device including the ECUs 102 to make this decision, and this decision-making process should be safety tested as well. The software update 902 here would need to be planned and tested before loading them somewhere on the vehicle's software application 112. This automated approach would be valuable on an autonomous vehicle as the automatic deployment of a software update 902 in response to a critical security event could permit a vehicle to maintain their autonomous function while mitigating an attack.

At operation 1104, a procedure to install the software update 902 is initiated. In an example responsive to occurrence of the trigger at operation 1102, one or more software update 902 may be sent to the ECU 102, where the software update 902 indicates which placeholder instruction(s) 202 and placeholder code area(s) 204 to update, as well as the updated code to be included in each. Based on the implementation, the software update 902 may define changes to the placeholder instructions 202, to the placeholder code areas 204, to the patch table 502, and/or to the MAC table 802. In another example, one or more of software updates 902 may be sent to a different ECU 102 on the vehicle network to update that other ECU 102. In yet another example, the software update 902 may indicate to activate an already loaded update resident to the ECU 102 onto another ECU 102 of the vehicle as a preventative measure. In another example, another mechanism may be used to update the vehicle, such as an internal mechanism within the vehicle (e.g., a flash drive), or potentially a service call to a service location/dealership.

At operation 1106, the software update 902 is loaded into a memory 106. In an example, the instructions from the OTA update, flash drive, or other mechanism may be applied to the placeholder code area(s) 204 of the one or more ECUs 102 to be updated.

At operation 1108, the placeholder instruction(s) 202 are replaced as indicated in the update, e.g., as specified by the placeholder instruction update 906 of the software update 902. For example, the placeholder instruction 202 may be replaced with a JMP instruction to the block of code implementing the software update 902. Or, the placeholder instruction 202 may be replaced with a JMP instruction to a block of code implementing a remote procedure call to a remote ECU 102 implementing the software update 902. In another example, the patch-ready bit 504 of the patch table 502 may be updated to indicate that the patch is present in the placeholder code area 204. In still another example, the signature 804 of the patch maybe updated in the MAC table 802 to allow the placeholder instructions 202 to conditionally jump to the patch in the placeholder code area 204 upon a match of the signature 804.

At operation 1110, the procedure for applying the software update 902 is completed. For example, the ECU 102 may be restarted, and/or the remote ECU 102-R may be restarted. After operation 1110, the process 1100 ends.

Variations on the disclosed techniques are possible. In one example, the placeholder instructions 202 the original code segment 108 may be extended to implement other unique security features. One such feature is randomly adding blocks of delay to thwart a timing attack. If the amount of delay inserted at these placeholder instructions 202 is varied across a fleet of vehicles (or other devices that are seemingly identical to an adversary), an attacker would have a challenging time trying to design a timing-based attack on one vehicle and then attacking another as the timing characteristics will vary.

As one possibility, the placeholder instructions 202 may call the same general function as detailed in one of the above options. However, instead of a simple RET instruction, the function may be updated to perform a random delay while remaining within the current task's deadline. Similarly, instead of adding a random amount of timing delay, a delay budget may be used such that the sum of the individual random timing delays adds up to the delay budget. In such a case, the relative amount of timing delay across the code may be adjusted such that the execution of the code remains constant time despite variation. Thus, there is no information leaked based on timing.

Additionally, the placeholder instructions 202 may be inserted into the code to produce a pattern unique to the software application 112 of the ECU 102. For example, a pattern of placeholder instructions 202 may serve as a unique “barcode” or fingerprint for that software application 112. The barcode could act as an integrity check for the software application 112 of the ECU 102, permit validation of the software application 112 without requiring keys or cryptographic hardware, and a unique identifier to more closely associate a vehicle with its vehicle identification number (VIN). This may also allow for identification of whether a specific version of software was leaked and/or the leaker of the software version. In some cases, the pattern of placeholder instructions may be chosen to perform a dual function, both to act as placeholder instructions (i.e. do not modify the control flow of the program) and also to induce a specific power consumption change when the power consumption is measured externally. This can also act as a fingerprint that is measured externally with an external device.

Another security extension for the placeholders is to use them to gather more information about a system instead of using them for a patch. If a Product Security Incident Response Team (PSIRT) team needs to perform a root cause analysis about a particular ECU, the placeholders could be used to insert loggers or some other information gathering code. Since the placeholder code 204 may be called from many or all of the placeholder instructions 202, and since the return address or other execution information may be available, a log of the operation of the software application 112 may be easily generated. Such a patch may also be extended by including a mechanism to first perform this root cause analysis and then request a necessary patch (if needed).

Additional checks may also be implemented using the placeholder instructions 202 to meet timing requirements. For instance, during the creation of a patch, the generated patch may be checked to verify that it requires, at most, a number of cycles that the originally replaced code required (otherwise, timing violations would be possible). Similarly, if a function is replaced, the new function may be tested to ensure that the inputs to the function are the same ones expected by the original function. The patch may also be verified against the same ASIL as the rest of the software. Advantageously, the validation may not require re-validation of the whole software but only of the software patch.

It should also be noted that the techniques discussed herein differ from other hot-patching techniques in key aspects. In hot-patching, code may be inserted in a binary to redirect control flow to a different memory location at run-time. In contrast, in the disclosed approaches the framework is supplied ahead of time at the original time of software creation. The disclosed approaches therefore have the advantage that checks on the binary to verify its correct execution are not required at run-time when the binary has been updated.

In another variation, the locations of the placeholder instructions 202 may be identified by a tool stack that builds the software application 112. For example, the tool stack may analyze source code being compiled to identify locations where placeholder instructions 202 may be useful, such as calls to cryptographic functions, beginnings of functions, ends of functions, etc. Thus, the placeholder instructions 202 mechanism may become an automatic part of the build process.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as read-only memory (ROM) devices and information alterably stored on writeable storage media such as floppy disks, magnetic tapes, compact discs (CDs), RAM devices, and other magnetic and optical media. The processes, methods, or algorithms can also be implemented in a software executable object. Alternatively, the processes, methods, or algorithms can be embodied in whole or in part using suitable hardware components, such as application specific integrated circuit (ASIC), field-programmable gate array (FPGA), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for facilitating minimal impact patching, comprising:
allocating one or more placeholder code areas within code segments of a software application;
identifying a plurality of locations within the code segments of the software application for placement of placeholders, the placeholders including placeholder instructions configured to selectively call code placed in the placeholder code areas; and
building the software application including the placeholder instructions and the placeholder code areas.

2. The method of claim 1, wherein identifying the plurality of locations includes one or more of:
locating the placeholders before calls to cryptographic functions located in the code segments of the software application;
locating the placeholders at beginnings of functions located in the code segments of the software application; or
locating the placeholders at ends of functions located in the code segments of the software application.

3. The method of claim 1, further comprising locating the placeholder instructions before and/or after security functions to allow the security functions to be augmented or replaced.

4. The method of claim 1, further comprising:
generating basic blocks of instructions and edges that are changes in control flow of the instructions; and
locating the placeholder instructions at the entry and/or exit points of the basic blocks.

5. The method of claim 1, further comprising locating the placeholder instructions to produce a pattern unique to the software application for identifying the software application.

6. The method of claim 1, further comprising choosing the placeholder instructions to include a power consumption pattern unique to the software application for identifying the software application.

7. The method of claim 1, wherein the placeholder instructions are predefined to be modified and/or replaced with other one or more instructions to call a section of code in the placeholder code areas that is not initially being called in the software application.

8. The method of claim 1, further comprising:
allocating a patch table within the software application, the patch table defining a data structure that includes a set of bits indicative of which of the placeholder instructions should execute a patch; and
defining the placeholder instructions to include a check whether a particular patch-ready bit corresponding to the respective placeholder instruction is set, followed a conditional jump based on a result of the check.

9. The method of claim 1, further comprising:
defining the placeholder instructions to include an unconditional call to the placeholder code areas, each unconditional call including a return address; and
including, in the placeholder code areas, functions that execute patches keyed to the specific placeholders based on the return address.

10. The method of claim 1, wherein a plurality of placeholders each call the same placeholder code area.

11. The method of claim 1, further comprising:
allocating a message authentication code (MAC) table within the software application, the MAC table defining a data structure that includes a unique signature corresponding to each of the placeholders; and
defining the placeholder instructions to include a check whether a particular signature corresponding to the respective placeholder instruction is a match to a MAC computed from the placeholder instructions, followed a conditional jump based on a result of the check.

12. The method of claim 11, further comprising maintaining the MAC table to a hardware security module.

13. A system for facilitating minimal impact patching, comprising:
an electronic control unit (ECU) having a memory and a processor, wherein the ECU is configured to receive a software application, the software application comprising:
one or more placeholder code areas allocated within code segments of the software application;
a plurality of locations within code segments of the software application at which placeholders are placed, the placeholders including placeholder instructions configured to selectively call code placed in the placeholder code areas; and
wherein the software application is built including the placeholder instructions and the placeholder code areas.

14. The system of claim 13, wherein to identify the plurality of locations includes one or more of to:
locate the placeholders before calls to cryptographic functions located in the code segments of the software application;
locate the placeholders at beginnings of functions located in the code segments of the software application; or
locate the placeholders at ends of functions located in the code segments of the software application.

15. The system of claim 13, wherein the placeholder instructions are located before and/or after security functions to allow the security functions to be augmented or replaced.

16. The system of claim 13, wherein a compiler generates basic blocks of instructions and edges that are changes in control flow of the instructions, and the placeholder instructions are located at the entry and/or exit points of the basic blocks.

17. The system of claim 13, wherein the placeholder instructions are located to produce a pattern unique to the software application for identifying the software application.

18. The system of claim 13, wherein the placeholder instructions are chosen to include a power consumption pattern unique to the software application for identifying the software application.

19. The system of claim 13, wherein the placeholder instructions are predefined to be modified and/or replaced with other one or more instructions to call a section of code in the placeholder code areas that is not initially being called in the software application.

20. The system of claim 13, wherein the software application further comprises:
a patch table allocated within the software application, the patch table defining a data structure that includes a set of bits indicative of which of the placeholder instructions should execute a patch,
wherein the placeholder instructions are defined to include a check whether a particular patch-ready bit corresponding to the respective placeholder instruction is set, followed a conditional jump based on a result of the check.

21. The system of claim 13, wherein the placeholder instructions are defined to include unconditional calls the placeholder code areas, each unconditional call including a return address and the placeholder code areas include functions that execute patches keyed to the specific placeholders based on the return address.

22. The system of claim 13, wherein a plurality of placeholders each call the same placeholder code area.

23. The system of claim 13, wherein the software application further comprises:
a MAC table allocated within the software application, the MAC table defining a data structure that includes a unique signature corresponding to each of the placeholders,
wherein the placeholder instructions include a check whether a particular signature corresponding to the respective placeholder instruction is a match to a MAC computed from the placeholder instructions, followed a conditional jump based on a result of the check.

24. The system of claim 23, wherein the MAC table is stored to a hardware security module of the ECU.
